(19) United States
(12) Patent Application Publication
(10) Pub. No.: US 2007/0182971 A1
(43) Pub. Date: Aug. 9, 2007

(54) REFERENCE SPECIMEN FOR MICROSCOPE AND MANUFACTURING METHOD THEREOF

(76) Inventors: Yuichiro Kubo, Tokyo (JP); Katsuhide Shimmo, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/672,281

(22) Filed: Feb. 7, 2007

(30) Foreign Application Priority Data
Feb. 8, 2006 (JP) P2006-031420

(51) Int. Cl. G01B 11/24

(52) U.S. Cl. 356/601

(57) ABSTRACT

In a reference specimen for a microscope, for use in calibration or inspection of a microscope, having an uneven structure in which convex portions having a prescribed height or concave portions having a prescribed depth are arrayed in a prescribed cycle on a substrate surface, as a material forming the uneven structure, a hydrolytically cured product of a metal alkoxide, or a cured product of an epoxy resin or an acrylic resin is used. The fine uneven structure is manufactured in the following manner. It is transferred by pressing a master plate against a molding material coated on a substrate, and cured, followed by release.

### BACKGROUND OF THE INVENTION

1. Field of the Invention

The present invention relates to a reference specimen for use in calibration or inspection of various microscopes including a scanning probe microscope, and a manufacturing method thereof.

2. Description of the Related Art

The scanning probe microscope is a microscope typified by an atomic force microscope or a scanning tunneling microscope. It is an apparatus for observing the fine surface shape by scanning the surface of a substance by the use of a pointed probe. With a scanning tunneling microscope, an object to be observed is limited to an electrically conductive specimen. However, with an atomic force microscope, a measurement is possible even for an electrically insulating specimen.

With the scanning probe microscope, scanning is mechanically carried out by means of a probe. The resulting electric signal is processed as an output image, thereby to measure the microscopic shape of the order of nanometers. Thus, the measurement is based on the mechanical movement of the probe. Therefore, the measurement result varies according to the object to be measured, the measurement conditions, or the changes in condition with time. Thus, an error may occur in the quantitative distance measurement result. In order to prevent such an occurrence of an error, desirably, a specimen for calibration, with known dimensions, is prepared. It is subjected to a measurement, if required, and the measurement results are calibrated.

Generally, by the use of a specimen for calibration, having a cyclic uneven structure with known dimensions, calibrations are carried out for either of, or both of the two-dimensional distance in the field of view of the microscope, and the distance in the direction perpendicular to the observation surface, i.e., the depth of the unevenness. Calibration is carried out when an apparatus is operated for the first time, when a change is made to an apparatus, when the measurement object, or conditions are changed, or in other cases. Further, it is periodically carried out in order to prevent the changes with time.

The shape of the specimen for calibration is generally such that concave portions each in the form of rectangular parallelepiped or quadrangular pyramid are arranged at regular intervals for the one for scanning probe microscope calibration. The dimension of the region where the concave portions are arrayed is about from several square micrometers to several hundreds square micrometers. Whereas, the cycle and the depth are divided into several levels according to the object to be calibrated. However, generally, the levels are respectively on the order of 100 nm to several tens micrometers and several nanometers to several micrometers (see, e.g., Non-Patent Document 1 or 2).

Further, for the scanning probe microscope, there are not only a problem of an error of the measurement distance, but also a problem of whether the shape of the surface of a specimen is reflected in the image of the measurement result with precision, i.e., whether a probe follows the shape of the specimen surface with precision. This problem will be described by reference to FIGS. 1A to 1C. As shown in FIG. 1A, when a specimen 2 having an uneven structure on the surface is scanned by means of a probe 1, it is possible to obtain a measurement image 5 reflecting the uneven structure of the specimen. However, as shown in FIG. 1B, when a foreign matter 3 is deposited on the probe 1, in a measurement image 6, the width of the concave portion is apparently observed to be narrower than the actual surface shape of the specimen 2. Further, as shown in FIG. 1C, when the foreign matter 4 is large, and is deposited onto the tip portion of the probe, a measurement image 7 may be the one with no bottom, different in shape from the actual concave portion. Such a phenomenon may occur not only upon the deposition of the foreign matter onto the probe but also upon the deformation of the probe due to abrasion or the like.

In order to detect such defective conditions of the probe tip, for example, a specimen for probe inspection having an uneven structure with a known cycle in the one-dimensional direction arrayed thereon is prepared, and scanned with the probe in the direction of the cycle. Herein, the uneven structure is set to such a structure as to allow a normal probe to enter into the bottom of the concave portion of the uneven structure. When the deposition of a foreign matter onto a probe or abrasion of a probe occurs, as shown in FIG. 1B or FIG. 1C, the probe ceases to follow the shape of the concave portion. Therefore, the measurement result becomes different from the shape of the concave portion of the specimen for calibration. As a result, it is possible to detect the defective conditions of the probe tip.

Conventionally, for manufacturing of a fine structure of a specimen for calibration or for inspection, a patterning technology and an etching technology are used in combination. For example, generally, on a silicon substrate, patterning by photolithography or electron beam drawing is carried out to form a mask. Through the mask, an uneven shape is manufactured by dry etching including ion beam etching.

Non-Patent Document 1: Products Catalog for AFM Tips, online, NanoWorld AG, searched on Nov. 25, 2005, Internet (URL, {HYPERLINK http://www.nanosensors.com/products_catalog.html, http:www.nanosensors.com/products_catalog.html})

Non-Patent Document 2: Sample for SPM calibration, online, TOYO Corporation, searched on Nov. 25, 2005, Internet (URL, {HYPERLINK http://www.toyo.co.jp/spm/kousei.htm”, http://www.toyo.co.jp/spm/kousei.htm})

Conventionally, manufacturing of a calibration specimen for a microscope has required a large scale apparatus such as an electron beam drawing apparatus or a dry etching apparatus. Further, processing into a fine shape requires delicate condition setting, which is required to be repeated every time one or a few specimens are manufactured. This requires a long time. For this reason, the manufactured specimen for calibration is expensive, and it cannot be used easily. This results in a problem of limited frequency in use. Further, the effective area usable for calibration is small, and hence there is another problem that the calibration operation is difficult to carry out.

For the same reason, in actuality, even though the specimen for inspecting the conditions of the probe tip is also in demand, a specimen for calibration is generally substituted therefor. There is no specimen specifically for grasping the changes due to the deposition of a foreign matter onto a probe, or the abrasion of a probe with precision. This causes a loss of precision of the measurement.

### SUMMARY OF THE INVENTION

The invention was made in order to solve the problems. It is an object of the invention to provide a reference specimen for use in calibration or inspection of a microscope which can be manufactured for a short time by a simple process.

A reference specimen for a microscope of the present invention has an uneven structure in which convex portions having a prescribed height or concave portions having a prescribed depth are arrayed in a prescribed cycle on a substrate surface. A material forming the uneven structure includes a hydrolytically cured product of a metal alkoxide.

Incidentally, the reference specimens for a microscope herein include a specimen for calibration, for use in calibration of the distance, and a specimen for inspection, for use in inspection of the probe tip.

This material can be molded while having fluidity, and can be cured in the state. This enables manufacturing of a specimen for a short time without using a large scale apparatus. Therefore, it becomes possible to feed a large quantity of reference specimens at a low cost. Further, the material is excellent in weather resistance after curing, and it compares in durability favorably with conventional specimens for calibration.

Incidentally, the convex portions having a prescribed height or the concave portions having a prescribed depth herein referred to each denote the distance between the top and the bottom of the unevenness. This distance is assumed to be roughly constant within the effective area of the reference specimen.

Whereas, other materials forming the uneven structure are assume to include a cured epoxy resin or acrylic resin.

This material can be molded while having fluidity, and can be cured in the state. This enables manufacturing of a specimen for a short time without using a large scale apparatus. Therefore, it becomes possible to feed a large quantity of reference specimens at a low cost. As the resin material, an epoxy resin or an acrylic resin can be used. However, an epoxy resin is more desirable because it less shrinks upon curing, and has a relatively high hardness as compared with an acrylic resin.

The reference specimen is desirably used for a scanning probe microscope capable of observing an electrically insulating specimen.

The specimen is basically an insulating material, and it can be processed into a fine shape. Therefore, it is suitable as a reference specimen for a scanning probe microscope capable of observing an electrically insulating specimen.

However, to the hydrolytically cured product of a metal alkoxide, an electric conductivity can be imparted according to the metal component included therein. When a reference specimen is manufactured by the use of such a material, it is possible to even provide reference specimens not only for a scanning probe microscope capable of observing an electrically insulating specimen, but also for a microscope covering an electrically conductive specimen such as a scanning tunneling microscope.

Further, it is preferable that the uneven structure is one-dimensionally arrayed in a prescribed cycle.

The reference specimen in which the uneven structure is one-dimensionally arrayed in a prescribed cycle can be applied for inspection of the tip state of a probe. As with the foregoing specimens for calibration, this enables manufacturing of a specimen for a short time without using a large scale apparatus. Therefore, it becomes possible to feed a large quantity of reference specimens at a low cost.

Incidentally, it is desirable that the prescribed height of the convex portions or the prescribed depth of the concave portions is set in the range of 10 nm or more and 2 μm or less.

When the height or the depth is less than 10 nm, it approaches a limit of measurement of the microscope targeted for calibration. Thus, it is not desirable to carry out calibration in such a state. Whereas, when the height or the depth exceeds 2 μm, it generally becomes difficult to form the specimen with precision by the method of this invention.

Whereas, it is desirable that the region where the uneven structure is formed has an area of 3×3 mm or more.

When the reference specimen has an area of 3×3 mm or more, the calibration or inspection operation becomes easy. On the other hand, it is easy to manufacture the specimen of such a range of dimensions with molding.

A method for manufacturing a reference specimen for a microscope, for use in calibration or inspection of a microscope, including an uneven structure having a prescribed height arrayed in a prescribed cycle on a substrate surface, sequentially includes: a coating step of coating a molding material having fluidity on a substrate, or filling and coating it in a molding die; a molding step of making the substrate and the molding die face each other across the molding material having fluidity interposed therebetween, and pressurizing them; a curing step of applying an energy of heat or light thereto under pressure, and curing the molding material in the molding die; and a releasing step of releasing the molding die.

When the molding die is prepared, it becomes possible to manufacture a large number of reference specimens for a short time by such steps.

In a molding process, a conventional micromachining technology based on a patterning technology and an etching technology may be used only in a master plate manufacturing step. For this reason, it is possible to largely improve the low productivity in the conventional step in which micromachining must be basically carried out for every specimen. As a result, it becomes possible to feed reference specimens for a microscope each to every more minute measurement range than ever. Thus, it is possible to keep high the precision of the microscopic measurement by the calibration using it. Further, the reduction of the cost resulting from the improvement of the productivity enables the feed of a large quantity of specimens as for use in inspection of the state of the probe tip.

On the other hand, this technology is not reduced in productivity even when the machining area is enlarged. This facilitates the manufacturing of a reference specimen having a large area. Thus, it is possible to provide a reference specimen which is far easier to handle as compared with conventional ones. Further, use of a sol-gel material enables the specimen of the invention to have a weather resistance which compares favorably with conventional specimens for calibration.

### BRIEF DESCRIPTION OF THE DRAWINGS

FIGS. 1A to 1C are Views illustrating the problems in measurement of the shape of a scanning probe microscope;

FIGS. 2A to 2D are Views illustrating steps of molding and transfer;

FIG. 3 is a perspective view showing one example of a reference specimen for measurement distance calibration of the invention; and

FIG. 4 is a perspective view showing one example of a reference specimen for probe tip inspection of the invention.

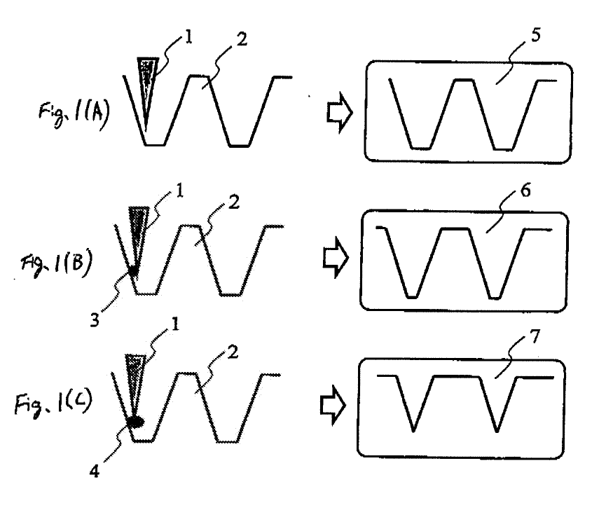

### DESCRIPTION OF THE PREFERRED EMBODIMENTS

A basic manufacturing process of a reference specimen for a microscope of the present invention will be described.

In the invention, the fine uneven structure to be provided in the reference specimen is manufactured by a molding technology. This requires a master plate (molding die) for transferring the uneven structure. This master plate is manufactured with a conventional technology. The surface shape is inverted by transfer. Therefore, a master plate in an inverted shape of the necessary shape is previously prepared.

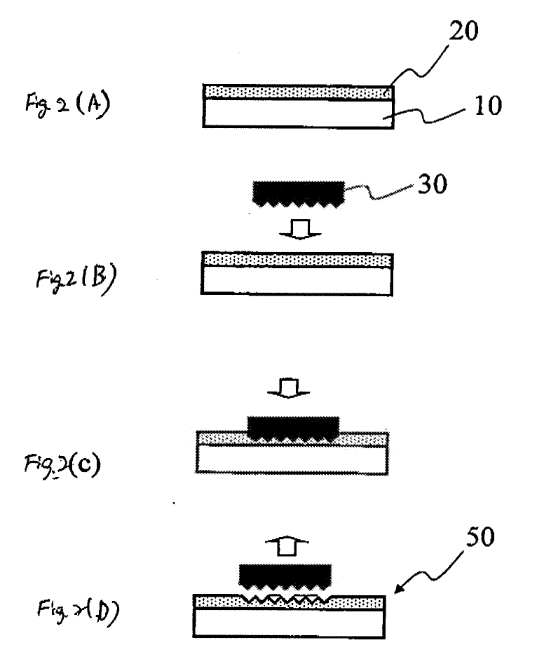

The master plate surface is subjected to a release treatment, and transfer of the uneven structure to a molding material is carried out. Namely, as shown in FIG. 2A, on a flat plate-like substrate 10, a molding material 20 having fluidity is coated (coating step). A master plate 30 having the fine shape is pressed thereagainst as shown in FIG. 2B (molding step). Then, the molding material is applied with an energy of heat, light, or the like, necessary for curing of the molding material while being pressed by the master plate, and thus under pressure as shown in FIG. 2C, thereby to cure the molding material (curing step). Thereafter, as shown in FIG. 2D, release is carried out (releasing step), resulting in a substrate (molded product) 50 on which the first fine shape has been transferred. Incidentally, in the coating step, the molding material may be coated in such a manner as to fill the concave portions of the master plate.

Below, specific examples of the reference specimen for a microscope will be described in more details.

### EXAMPLE 1

In this example, a reference specimen for a microscope as shown in FIG. 3 is manufactured.

First, a master plate serving as a molding die for manufacturing of a specimen is manufactured by a dry etching technology. The master plate has a structure in which fine convex portions (60 nm in height) are two-dimensionally arrayed in a cycle of 200 nm on the surface of a quarts substrate. The region where the convex portions are present is about 5×5 mm.

The master plate is subjected to a release treatment in order to preventing the deposition of a molding material during transfer. In this example, as the molding material, a sol-gel material is used. Therefore, a fluorine type monomolecular film was deposited thereon as a release treatment. The fluorine type monomolecular film can ensure the mold releasability. In addition, the release film can prevent the loss of the shape following property of the transfer molding product to the master plate.

The sol-gel material solution was formed by mixing methyl triethoxysilane and tetraethoxysilane, ethanol, and an acid aqueous solution. Molding and transfer are basically carried out in the order shown in FIGS. 2A to 2D. The sol-gel material solution was coated on the 50 mm square quartz substrate by spic coating. Then, the master plate and the substrate on which the sol-gel material solution had been coated were stacked one on another, and a pressure of 50 kg/cm² was applied thereto. As it was, the substrate temperature was increased to 80° C., and pressurization was continued for 20 minutes to cure the sol-gel material. Then, the pressure was released, so that the master plate and the quartz substrate were torn off from each other. Thereafter, sintering was carried out at 350° C. for 20 minutes.

The manufactured reference specimen has a structure in which fine concave portions (60 nm in height) are two-dimensionally arrayed in a cycle of 200 nm on the surface as shown in FIG. 3. The material is mostly SiO₂, and an electrically insulating material. Therefore, it is suitable for calibration of an atomic force microscope. It was actually used for calibration, then, the following was indicated: the uneven structure has dimensions of 5×5 mm, and hence the calibration operation is easy, and a sufficient calibration precision can be obtained as compared with a conventional specimen for calibration.

For the weather resistance, there was performed a high temperature high humidity test in which a specimen is held at a temperature of 75° C. and a humidity of 90% for 1000 hours. However, the specimen showed no changes in surface shape and film conditions. Thus, it has been shown that the specimen has sufficient weather resistance.

Incidentally, in this example, a description was given to the specimen for calibration, configured such that square concave portions are provided in the flat surface. However, as the shape of the concave portion, a rectangle, a polygon, a circle, or the like can be selected according to the object of calibration. Alternatively, if required, not concave portions but convex portions may be provided.

Further, in this example, the depth of the concave portion (the distance between the flat surface portion and the concave portion bottom) was set at 60 nm. However, it is not limited thereto, and can be changed according to the object of the calibration. However, when the depth is less than 10 nm, it approaches a limit of measurement of the object to be calibrated. Therefore, this is not desirable for carrying out precise calibration, and at the same time, this also makes it difficult to form concave portions with high precision. Whereas, when the depth exceeds 2 μm, it becomes difficult to form the concave portions with precision by the method of this invention. From the description up to this point, it is desirable that the depth of the concave portion is set at 10 nm or more and 2 μm or less according to the object of the calibration.

### EXAMPLE 2

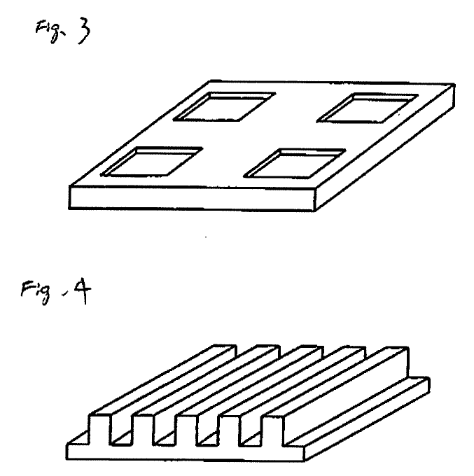

A reference specimen in the shape as shown in FIG. 4 is manufactured in the same manner as in Example 1. It is in the shape of a structure in which grooves with a depth of 100 nm and a cross section in the form of a trapezoid are arrayed in parallel in a cycle of 150 nm. The molding material is the same as that of Example 1.

The manufactured specimen was actually used for inspection of the probe tip of an atomic force microscope. Comparison between the measurement results and the surface uneven shape of the previously prepared specimen can confirm whether defective conditions occur at the probe tip. Further, the reference specimen is measured upon the start of the measurement and after the completion of a plurality of cycles of the measurement, and both are compared. This can also confirm whether defective conditions at the probe tip occur or not during the measurement.

When a foreign matter was deposited on the probe, the groove depth changed from 100 nm to 84 nm, and thus, it was not possible to measure the flat surface at the bottom. It was possible to observe such a specific change or the like. Thus, it was possible to confirm that this specimen is useful for the confirmation of the measurement precision and the control of probes.

Incidentally, in this example, the groove depth is set at 100 nm. However, for inspection of the probe tip, it is generally preferable to use grooves with a depth of about 50 to 300 nm.

### EXAMPLE 3

A reference specimen for a microscope is manufactured by the use of the same master plate as that in Example 1, and with an ultraviolet-curable epoxy resin as the molding material.

As the glass substrate, a quartz glass substrate of the same dimensions as those in Example 1 was used. First, an epoxy resin material having fluidity was coated on the glass substrate by a micropipette. On the glass substrate on which the epoxy resin material had been coated, a molding die was placed, and pressurization was carried out. Then, an ultraviolet ray was applied thereto from the glass substrate back side to cure the epoxy resin. Then, the molding die was torn off therefrom for mold releasing. As a result, the epoxy material onto which the surface shape of the molding die had been transferred was formed on the glass substrate surface. The glass substrate was sintered at 100° C. for 1 hour.

When an epoxy resin is used, pressurization or keeping of the high temperature conditions is not required. Therefore, this case has a feature of being capable of manufacturing a reference specimen for a microscope with a simpler process.

The present invention can be not only applied to a reference specimen for calibration or inspection of a scanning probe microscope, but also applied as reference specimens covering, for example, an optical microscope, an electron microscope, and other various microscopes.

1. A reference specimen for a microscope, for use in calibration or inspection of a microscope, comprising:
an uneven structure in which convex portions having a prescribed height or concave portions having a prescribed depth are arrayed in a prescribed cycle on a substrate surface;
wherein a material forming the uneven structure includes a hydrolytically cured product of a metal alkoxide.

2. The reference specimen for a microscope, for use in calibration or inspection of a microscope, comprising:
an uneven structure in which convex portions having a prescribed height or concave portions having a prescribed depth are arrayed in a prescribed cycle on a substrate surface;
wherein a material forming the uneven structure includes a cured epoxy resin or acrylic resin.

3. The reference specimen for a microscope according to claim 1, wherein the microscope is a scanning probe microscope capable of observing an electrically insulating specimen.

4. The reference specimen for a microscope according to claim 1, wherein the uneven structure is one-dimensionally arrayed in a prescribed cycle.

5. The reference specimen for a microscope according to claim 1, wherein the prescribed height of the convex portions or the prescribed depth of the concave portions is set in the range of 10 nm or more and 2 μm or less.

6. The reference specimen for a microscope according to claim 1, wherein the region where the uneven structure is formed has an area of 3×3 mm or more.

7. A method for manufacturing a reference specimen for a microscope, for use in calibration or inspection of a microscope, including an uneven structure having a prescribed height arrayed in a prescribed cycle on a substrate surface, the method sequentially including:
a coating step of coating a molding material having fluidity on a substrate, or filling and coating it in a molding die;
a molding step of making the substrate and the molding die face each other across the molding material having fluidity interposed therebetween, and pressurizing them; and
a curing step of applying an energy of heat or light thereto under pressure, and curing the molding material in the molding die; and
a releasing step of releasing the molding die.

8. The reference specimen for a microscope according to claim 2, wherein the microscope is a scanning probe microscope capable of observing an electrically insulating specimen.

9. The reference specimen for a microscope according to claim 2, wherein the uneven structure is one-dimensionally arrayed in a prescribed cycle.

10. The reference specimen for a microscope according to claim 2, wherein the prescribed height of the convex portions or the prescribed depth of the concave portions is set in the range of 10 mm or more and 2 μm or less.

11. The reference specimen for a microscope according to claim 2, wherein the region where the uneven structure is formed has an area of 3×3 mm or more.
